(19) United States
(12) Patent Application Publication
(10) Pub. No.: US 2016/0043763 A1
(43) Pub. Date: Feb. 11, 2016

(54) SMART PHONE SPLASH WATER PROTECTION HOUSING

(71) Applicant: Harald RICHTER, Engelsbrand (DE)

(72) Inventor: Harald RICHTER, Engelsbrand (DE)

(21) Appl. No.: 14/453,557

(22) Filed: Aug. 6, 2014

(51) Int. Cl. H04B 1/3888

(52) U.S. Cl. CPC H04B 1/3888

(57) ABSTRACT

In a splash water protection housing for accommodating smart phones which housing has a base part and a lid hinged to the base part, a support plate provided with slide-resistant pads is disposed in the base part supported by springs so as to press a smart phone disposed on the support plate into contact with the closed lid which has windows covered by a transparent foil in order to permit actuation of the smart phone via the transparent sheet while the smart phone is held in place by being resiliently pressed by the support plate via the slide-resistant pads against the lid.

### BACKGROUND OF THE INVENTION

The invention resides in a splash water protection housing for smart phones, which is designed especially for use in connection with bicycles and which protects a smart phone disposed therein from rain or other splash water.

Various embodiments of such splash water protection housings for smart phones are commercially available. They are generally boxes which are adapted to accommodate a particular smart phone and comprise a tub-like base part for receiving the smart phone and a lid which is hinged along one side of the base part and which has windows provided with a transparent foil formed on the front side of the lid so that the smart phone can still be operated by actuating the touch screen of the smart phone through the foil.

However, the known splash water protection housings for smart phones are unsatisfactory in some respects. With regard to the multitude of smart phone models which are commercially available and the rapid model changes, it is desirable for the consumer as well as for the manufacturer to provide a splash water protection housing which is capable of accommodating different smart phone models. This however requires that the smart phone is securely and non-slidably disposed in the housing and can easily be used independently of the size of the smart phone.

It is therefore the object of the present invention to provide a splash water protection housing for smart phones, which is capable of safely and securely accommodating and supporting smart phones of various sizes and configurations, that is, to provide a universal smart phone protection housing.

### SUMMARY OF THE INVENTION

In a splash water protection housing for accommodating smart phones which housing has a base part and a lid hinged to the base part, a support plate provided with slide-resistant pads is disposed in the base part supported by springs so as to press a smart phone disposed on the support plate into contact with the closed lid which has windows covered by a transparent foil in order to permit actuation of the smart phone via the transparent sheet while the smart phone is held in place by being resiliently pressed by the support plate via the slide-resistant pads against the lid.

With this protection housing smart phones of different sizes and configurations and also of different thicknesses can be securely engaged within the housing when the lid is closed. With the support plate being resiliently arranged within the housing the smart phone placed into the housing is biased against the lid of the housing so that, with the lid closed, there is no play between the smart phone and the housing lid and, with the support plate being provided with slip-resistant surface areas, the smart phone is also prevented from lateral sliding.

As a result, the invention provides for a universal smart phone splash water protection housing, which is suitable for example for use in connection with bicycles or motorcycles where substantial vibrations may occur but the smart phone is still safely retained in the housing.

An exemplary embodiment of the invention will be described below on the basis of the enclosed drawings.

### BRIEF DESCRIPTION OF THE DRAWINGS

FIG. 1 shows in a perspective view a splash water protection housing with a lid which is shown open,

FIG. 2 shows a perspective view of the splash water protection housing with the lid closed,

FIG. 3 is a perspective rear view of the splash water protection housing with the lid closed, and

FIG. 4 is a cross-sectional view of the splash water protection housing with the lid closed.

### DESCRIPTION OF EXEMPLARY EMBODIMENT

As shown in the drawings, the smart phone protection housing according to the invention has a tub-like base part 1 and a lid 2 which is hinged to the base part 1, wherein the base part 1 and the lid 2 are provided with co-operating locking elements 11, 21.

As shown in the cross-sectional view of FIG. 4 an also tub-shaped insert 3 is disposed in the base part 1 and has side walls which projects upwardly above the base part 1. It is provided at its upper end with a seal ring 4 which is inserted into an annular groove 41 formed into the upper end of the upwardly projecting side walls of the insert 3 and which engages the inner surface of the lid 1 when the lid is closed. With the lid 2 closed, the insert 3 forms with the inner lid surface a fully water-tight chamber so that a smart phone disposed therein is securely protected from splash water even if the water should pass through gaps between the base part 1 and the lid 2. Furthermore, the base part 1 is provided with small drain openings 12 arranged in the lower edge area so that water that may have entered the space between the inner and the outer tub-shaped parts can be drained.

As further shown in FIG. 4, a smart phone support plate 5 is arranged in the insert 3 supported thereon by compression springs 6 and provided at the top side with slide preventing smart phone support areas 51.

The splash water protection smart phone housing can therefore accommodate smart phones of different thicknesses since the support plate 5 is pressed downward against the force of the springs 6 to accommodate a particular smart phone. The arrangement is such that the support plate is pressed down somewhat even if the smart phone placed in the housing is relatively thin to ensure that the smart phone is pressed by the springs 6 and the support plate 5 against the inner wall of the lid 2 when the lid is closed. The smart phone is then firmly engaged, that is, there is no play so that it cannot wiggle. Furthermore, the slide-resistant support areas 51 of the support plate on which the smart phone is supported with some engagement pressure provided by the springs 6 prevent the smart phone from sliding if its outside dimensions are smaller than the space provided in the insert 3.

The springs 6 as shown in FIG. 4 are spiral compression springs. However, also leaf springs may be used.

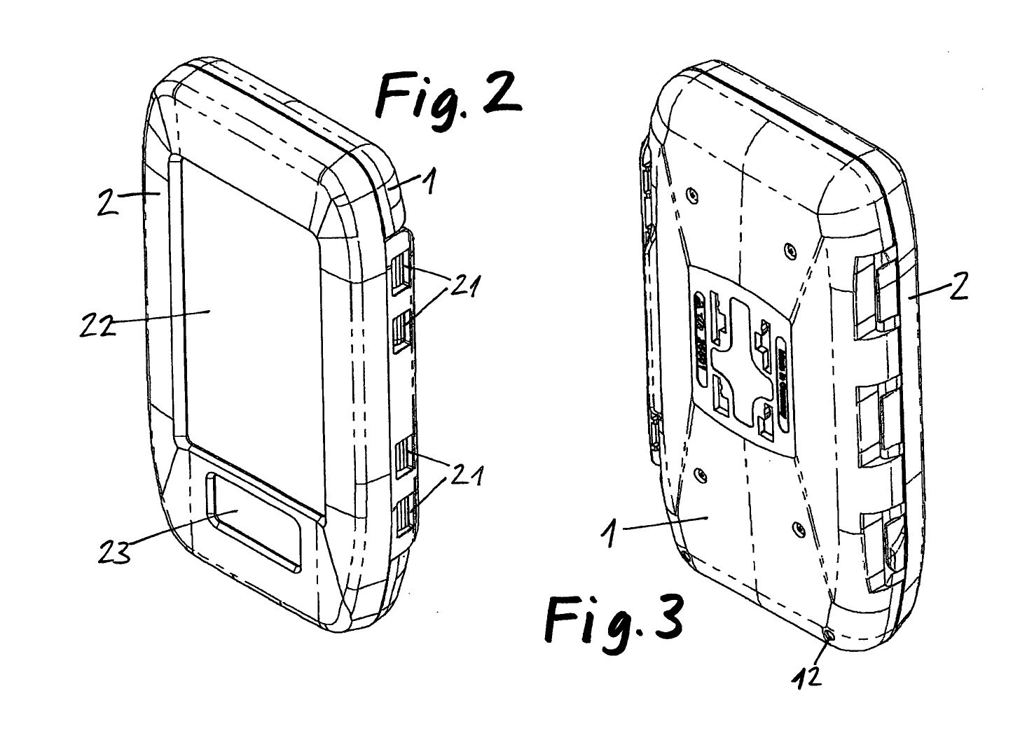

As shown in particular in FIG. 2, the front wall of the lid 2 is provided with two windows 22, 23, which are covered at the inside by a transparent foil 7 which is firmly connected to the lid and with which also the seal ring 4 is engaged when the lid 2 is closed as shown in FIG. 4.

Via the windows 22, 23, all actuation areas of the smart phone can be touch-actuated so that no flash water can reach the splash water protected smart phone in the housing and damage the smart phone.

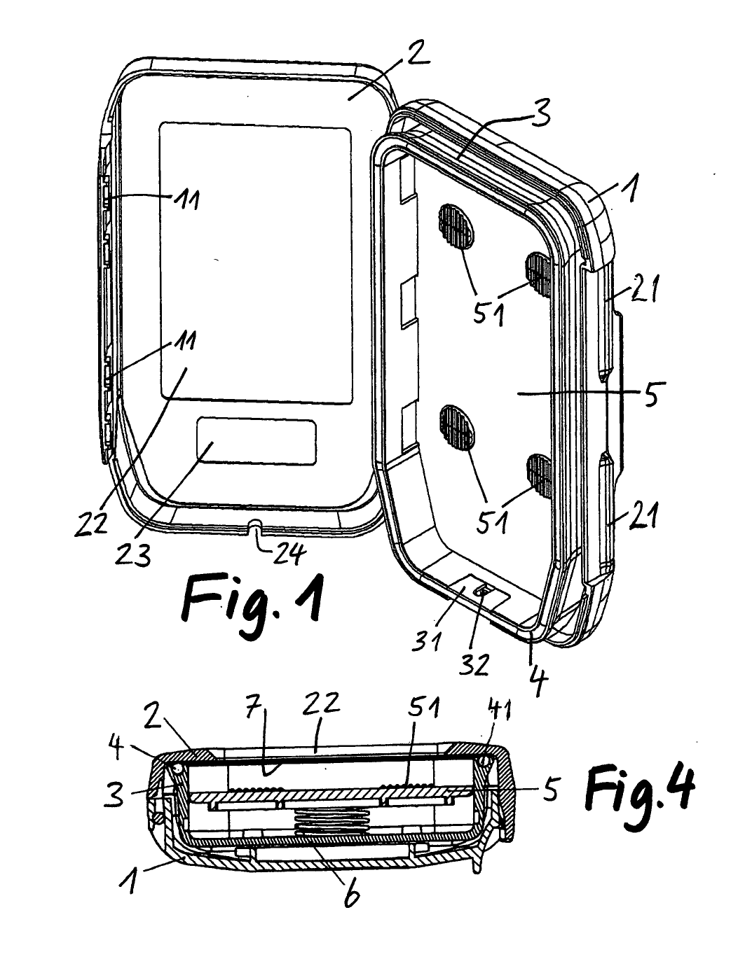

FIG. 1 shows the splash water protection housing in an open position where it can be seen that, at the lower, narrow side wall of the insert 3, an opening 32 is provided in the wall part 31 through which a charger cable can extend. In the lower small side wall area of the lid 2, a corresponding slit-opening is provided. In the insert 3, the wall part 31 is in the form of a removable wall part which consists of an elastic rubber-like sealing material and which, upon lifting of the seal ring 4, can be removed or inserted. The opening 32 is a slot opening which is so shaped that its walls sealingly extends around the charger cable when the wall part 31 is installed. In order to prevent that there is an opening when no charger cable is used, two wall parts 31 are provided, one with the opening 32 as shown and one without opening which is not shown, which can be used selectively.

At its backside, as shown in FIG. 3, the housing base part 1 is provided with coupling structures in the form of locking slots for coupling the housing base to a mounting plate of an apparatus carrier with a hook arrangement which apparatus carrier is mounted for example to the handlebar of a bicycle or a motor bike.

What is claimed is:

1. A splash water protection housing for smart phones comprising: a tub-shaped base part (1), a lid (2) pivotally connected to the base part (1) by a hinge and including at least one window (22, 23) across which a transparent foil (7) extends which permits touch activation of a touch screen area provided on the smart phone, a support plate (5) arranged in the base part (1) for supporting the smart phone and springs (6) arranged between the support plate (5) and the base part (1) so that, with the lid (2) closed, a smart phone placed into the housing is pressed against the lid (2) with a predetermined pressure, the support plate (5) being provided with friction pads (51) having friction surfaces for retaining the smart phone in place on the support plate (5).

2. The splash water protection housing for smart phones according to claim 1, wherein the springs (6) comprise one of coil springs and leaf springs.

3. The splash water protection housing for smart phones according to claim 1, wherein an also tub-shaped insert (3) is arranged in the base part (1) and the support plate (5) is supported via he springs (6) in the tub-shaped insert (3).

4. The splash water protection housing for smart phones according to claim 3, wherein the tub-shaped insert (3) includes a bottom wall and side walls with an upper edge which is provided with a seal ring (4) which, when the lid (2) is closed, sealingly engages the lid (2) so as to form a water-tight containment for the smart phone within the splash-water protection housing.

5. The splash water protection housing for smart phones according to claim 4, wherein the insert is provided at one of its side walls with a removable wall part (31) which is connect able to the side wall in a sealing fashion and which includes an opening (32) for accommodating a charger cable which extends through the opening in a water-tight manner and that a wall part (31) without opening is provided for installation when the smart phone is to be disposed in the housing without a charger cable.

6. The splash water protection housing for smart phones according to claim 4, wherein the base part (1) includes at least one drain opening (12) for draining any splash water that may have entered through gaps behind the lid (2) and the base part (1).
